(19) United States
(12) Patent Application Publication
(10) Pub. No.: US 2025/0044468 A1
(43) Pub. Date: Feb. 6, 2025

(54) MACHINE-LEARNING BASED GEOBODY PREDICTION WITH SPARSE INPUT

(71) Applicant: Landmark Graphics Corporation, Houston, TX (US)

(72) Inventors: Marc Paul Servais, Abingdon (GB); Graham Baines, Abingdon (GB); Daniel Thomas-Possee, Abingdon (GB); Fan Jiang, Houston, TX (US); Konstantin Osypov, Houston, TX (US)

(21) Appl. No.: 18/362,402

(22) Filed: Jul. 31, 2023

(51) Int. Cl. G01V 1/28; G01V 1/30; G01V 1/34; G06N 3/08

(52) U.S. Cl. CPC G01V 1/282; G01V 1/30; G01V 1/345; G06N 3/08

(57) ABSTRACT

Some implementations may include a method for detecting, by a learning machine, a geobody in a seismic volume. The method may include receiving a first seismic input tile representing first seismic data from the seismic volume; receiving a first guide input tile including first labels that indicate presence of the geobody in a respective region in the seismic volume or absence of the geobody in the respective region, and one or more unlabeled regions that make no indication about presence or absence of the geobody; and determining, based on the first seismic input tile and the first guide input tile, a first prediction about geobody presence or absence in the seismic volume.

### TECHNICAL FIELD

The disclosure generally relates to the field of hydrocarbon exploration, and more specifically to predicting locations of geobodies in the Earth.

### BACKGROUND

In the field of hydrocarbon exploration, various approaches to detecting geobodies may include techniques of machine learning. For example, some machine learning approaches may detect salt, channels, chimneys, and other geobodies based on seismic data for a seismic volume. If the presence or absence of a specific geobody is known to a user, traditional machine learning approaches do not currently support a way of providing this “ground truth” data to the machine learning model without retraining the model using the ground truth as training data. Retraining a machine learning model can be costly in terms of computation time and does not guarantee improved predictions.

### BRIEF DESCRIPTION OF THE DRAWINGS

Implementations of the disclosure may be better understood by referencing the accompanying drawings.

FIG. 1 is a data flow diagram showing a traditional learning machine predicting likelihood of a geobody in a seismic volume.

FIG. 2 is a dataflow diagram showing a learning machine predicting likelihood of a geobody based on post-stack seismic data and additional ground truth information.

FIG. 3 is a block diagram showing an example guide input tile including labels.

FIG. 4 is a block diagram showing another example guide input tile that includes labels.

FIG. 5 is a block diagram showing an example output tile generated based on a seismic input tile and a guide input tile.

FIG. 6 is a block diagram showing output tiles generated based on a seismic input tile and an “unlabeled” guide input tile.

FIG. 7 is a block diagram showing an example output tile generated based on a seismic input tile and an “unlabeled” guide input tile.

FIG. 8 is a block diagram showing output tiles generated based on a seismic input tile and a labeled guide input tile.

FIG. 9 the data flow diagram showing operations and data flow for iteratively improving a prediction about a geobody in the seismic volume.

FIG. 10 is a data flow diagram illustrating a learning machine that utilizes a weighted loss function to predict where geobodies may be in a seismic volume.

FIG. 11 is a data flow diagram illustrating operations by which a learning machine generates a plurality of output tiles which indicate a prediction about a geobody in a seismic volume.

FIG. 12 is a block diagram illustrating example interpretations and predictions about a geobody in a seismic volume.

FIG. 13 is a block diagram illustrating a computer system, according to some aspects.

FIG. 14 a flow diagram illustrating a method for detecting, by a learning machine, a geobody in a seismic volume.

### DESCRIPTION OF IMPLEMENTATIONS

The description that follows includes example systems, methods, techniques, and program flows that embody implementations of the disclosure. However, this disclosure may be practiced without these specific details. For clarity, some well-known instruction instances, protocols, structures, and techniques may not be shown in detail.

### Overview

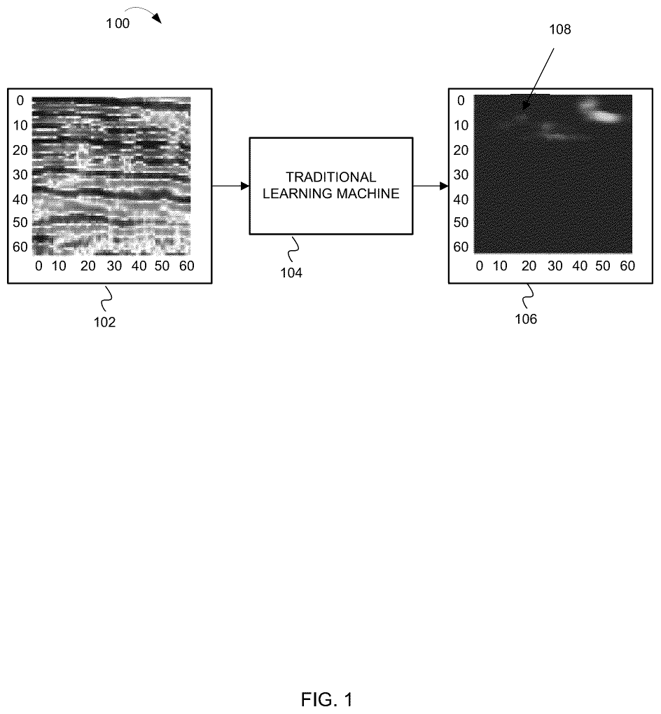

Some learning machines may be trained to predict, based on post-stack seismic data, where regions of salt, channels, chimneys, and other geobodies reside within a seismic volume. FIG. 1 is a data flow diagram showing a traditional learning machine predicting likelihood of a geobody in a seismic volume. In the dataflow 100, the traditional learning machine 104 may receive a seismic input tile 102 for a seismic volume. The seismic input tile 102 may indicate post-stack seismic data from the seismic volume. The learning machine's geobody prediction model may generate an output tile 106 indicating low likelihood of the geobody in a region 108 (low graphical contrast at a given region may indicate low likelihood of the geobody at that region). If additional ground truth information about geobodies in the seismic volume becomes available, the traditional learning machine 104 may not be able to accept the additional ground truth information without performing additional training.

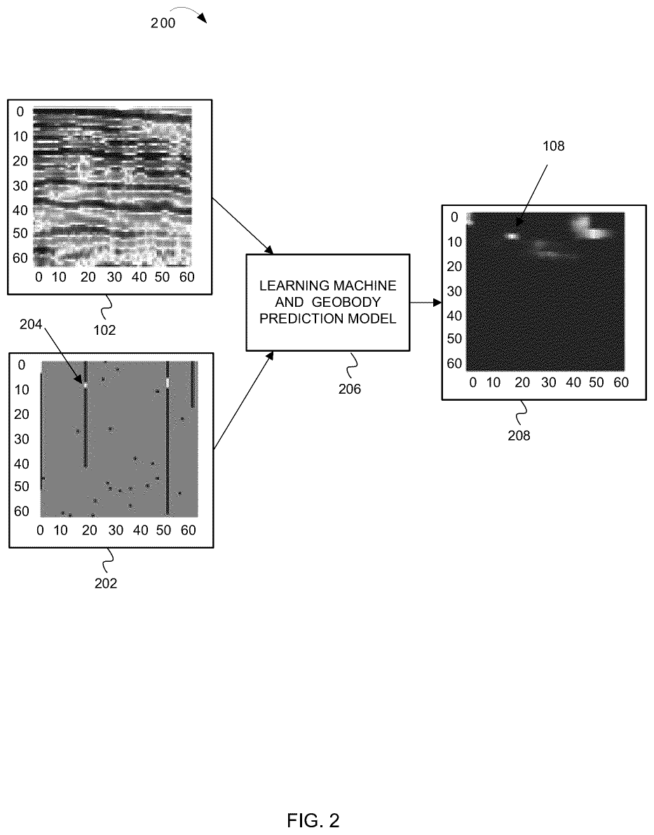

Some implementations enable learning machines to make predictions about geobodies in the seismic volume based on post-stack seismic data and additional ground truth information. FIG. 2 is a dataflow diagram showing a learning machine predicting likelihood of a geobody based on post-stack seismic data and additional ground truth information. In the dataflow diagram 200, the learning machine 206 may receive the seismic input tile 102 and a guide input tile 202. The guide input tile 202 may include additional ground truth information about the geobody in the seismic volume. The guide input tile 202 may include one or more labels that indicate regions in which the likelihood of the geobody is high. For example, a label for the region 204 of the guide input tile 202 may indicate a high likelihood that the geobody is present. Based on the seismic input tile 102 and the guide input tile 202, the learning machine's geobody prediction model may generate an output tile 208. The output tile 208 may graphically indicate a high likelihood for the geobody in the region 108. Hence, based on the guide input tile 202, the output tile 208 may indicate high likelihood of the geobody in region 108, whereas the output tile 106 (FIG. 1) may indicate lower likelihood of the geobody in region 108. In some implementations, the learning machine may predict that the geobody is absent from a region or absent altogether in a seismic volume.

In some instances, a user may provide the additional ground truth information at runtime. In one such an instance, a user may be unsatisfied with a prediction that was based on the post-stack seismic data without any additional ground truth information. The user may rerun the prediction with additional ground truth information. Hence, the learning machine may provide a new prediction that is based on both post-stack seismic data and new ground truth information about geobodies in the seismic volume. The new prediction may be more accurate than the original prediction. Thus, some implementations provide an iterative prediction process that may improve with successive iterations.

### SOME EXAMPLE IMPLEMENTATIONS

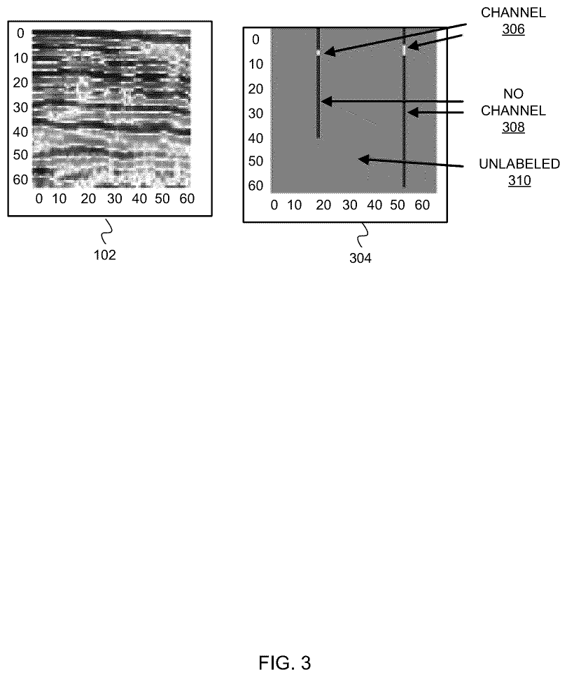

FIG. 3 is a block diagram showing an example guide input tile including labels. In FIG. 3, the guide input tile 304 may include three label types: labels that identify regions in which channels (a type of geobody) reside, labels that identify regions where no channels reside, and unlabeled regions. In the guide input tile 304, the “channel” label 306 identifies two regions that include channels. The “no channel” label 308 identifies two regions that do not include channels. The “unlabeled” label 310 identifies a region that has not been labeled. Hence, some implementations utilize a ternary labeling methodology. The learning machine 206 may receive the guide input tile 304 and the seismic input tile 102. Using these tiles, the learning machine 206 may generate an output tile (not shown) indicating a prediction about channels in a seismic volume. Hence, the learning machine 206 enables a user or automated process to provide additional ground truth information that may be used in making a prediction about geobodies in a seismic volume. Additionally, the learning machine 206 may utilize the labels 306, 308, and 310 during a training process by which the learning machine 206 learns how predict geobodies based on guide input tiles.

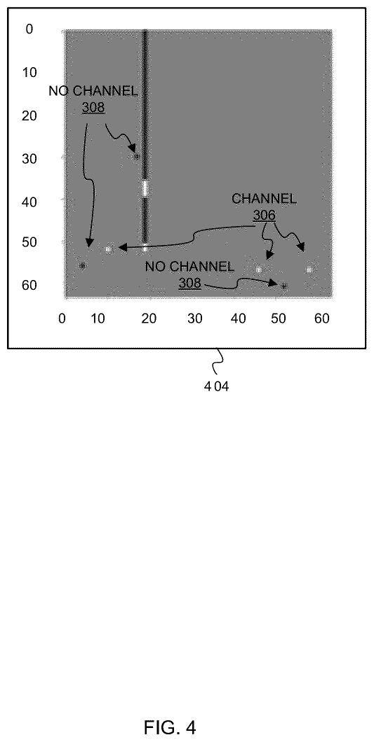

FIG. 4 is a block diagram showing another example guide input tile that includes labels. The guide input tile 404 may include additional regions that are labeled. More specifically, the label 306 may identify three regions that include channels. The “no channel” label 308 may identify three regions that do not include channels. Any labeled region may refer to an area or volume. Any labeled region may refer to a point or other shape representing the smallest unit of a seismic volume. Hence, a guide input tile may include labels referring to points or larger regions. The learning machine 206 may make predictions about geobodies based on the guide input tile 404 and the seismic input tile 102.

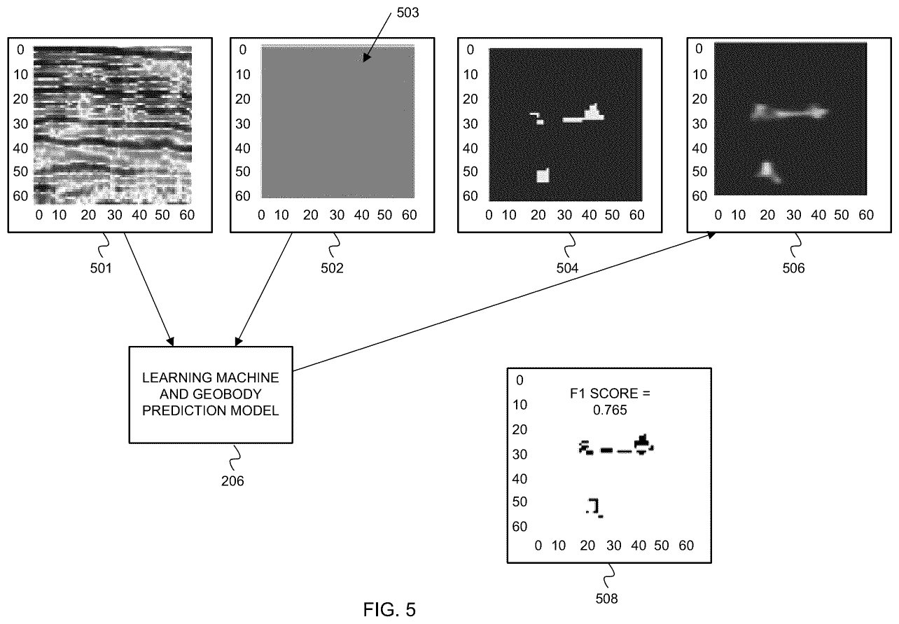

FIG. 5 is a block diagram showing an example output tile generated based on a seismic input tile and a guide input tile. In FIG. 5, the learning machine 206 may receive a seismic input tile 501 and a guide input tile 502. In the guide input tile 502, a label 503 may indicate that the entire guide input tile 502 has not been otherwise labeled. Hence, the guide input tile 502 adds no additional ground truth information to the seismic input tile 102. Based on the tiles 102 and 502, the learning machine 206 may generate an output tile 506 indicating a prediction about geobodies in the seismic volume. Lighter-colored regions in the output tile 506 may indicate nonzero likelihood of a geobody (such as a channel). The output tile 506 can be compared to a ground truth tile 504 that indicates where the geobody actually resides in the seismic volume. The tile 508 shows a difference between the ground truth tile 504 and the output tile 506. The tile 508 may be white where the output tile 506 agrees with the ground truth tile 504 and black where the prediction is incorrect. The tile 508 shows an associated F1 score for the geobody prediction model, where higher F1 scores indicate better performance by the geobody prediction model. The F1 score is 0.765 in the tile 508. Therefore, FIG. 5 shows a level of prediction accuracy based solely on the seismic input tile 102 because the guide input tile 502 does not provide any additional ground truth information.

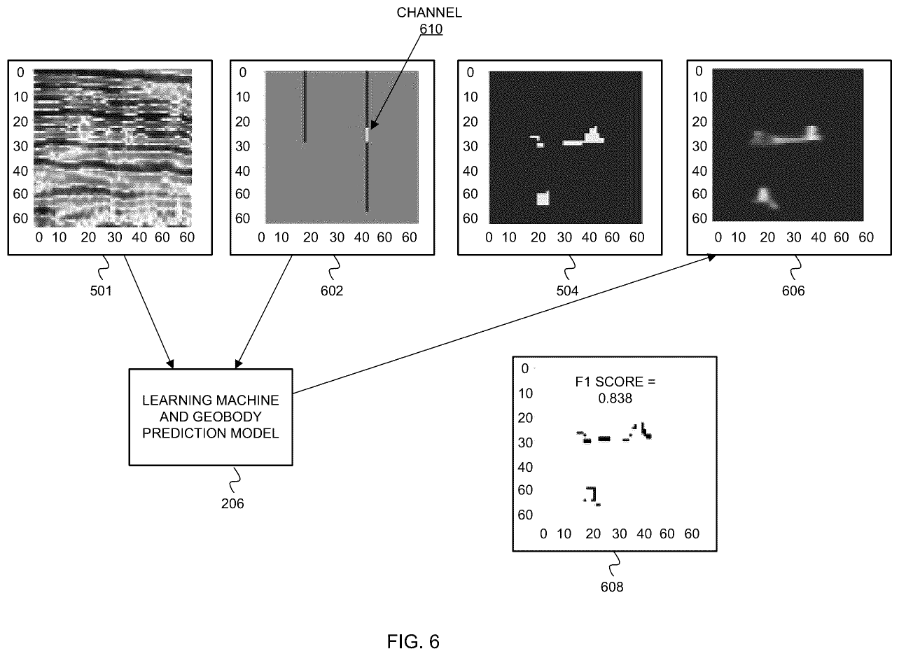

FIG. 6 is a block diagram showing output tiles generated based on a seismic input tile and a labeled guide input tile. In FIG. 6, the learning machine 206 receives a seismic input tile 501 and a guide input tile 602. The guide input tile 602 includes a label 610 indicating a region that includes a channel. Therefore, the learning machine 206 is making a prediction based on the seismic input tile 501 and additional ground truth information in the guide input tile 602. The learning machine may generate an output tile 606 indicating a prediction of where channels may exist in the seismic volume. The tile 608 shows a difference between the ground truth tile 504 and the output tile 606. The tile 608 may be white where the output tile 606 agrees with the ground truth tile 504 and black where the prediction is incorrect. The tile 608 indicates an F1 score of 0.838. The F1 score of the tile 608 is greater than the F1 score of the output tile 508 (see FIG. 5). Therefore, guide input tiles that include labeling may lead to more accurate predictions by the learning machine 206.

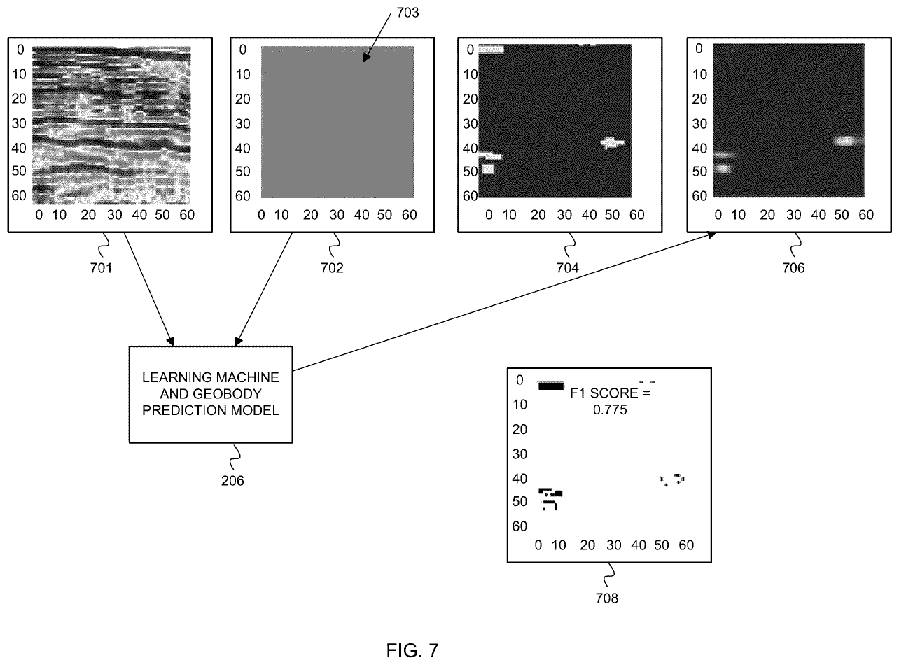

FIG. 7 is a block diagram showing an example output tile generated based on a seismic input tile and an “unlabeled” guide input tile. In FIG. 7, the learning machine 206 receives a seismic input tile 701 and a guide input tile 702. In the guide input tile 702, a “no label” 703 indicates that the entire guide input tile 702 has not been otherwise labeled. Hence, the guide input tile 702 adds no additional ground truth information to the seismic input tile 701. Based on the tiles 701 and 702, the learning machine 206 may generate an output tile 706 indicating a prediction about geobodies in the seismic volume. Lighter-colored regions in the output tile 706 indicate higher likelihood of a geobody (such as a channel). The output tile 706 can be compared to a ground truth tile 704 that indicates where the geobody actually resides in the seismic volume. The tile 708 shows a difference between the ground truth tile 704 and the output tile 706. The tile 708 may be white where the output tile 706 agrees with the ground truth tile 704 and black where the prediction is incorrect. The tile 708 shows an F1 score of 0.775. Therefore, FIG. 7 shows a level of prediction accuracy based solely on the seismic input tile 701 because the guide input tile 702 does not provide any additional ground truth information.

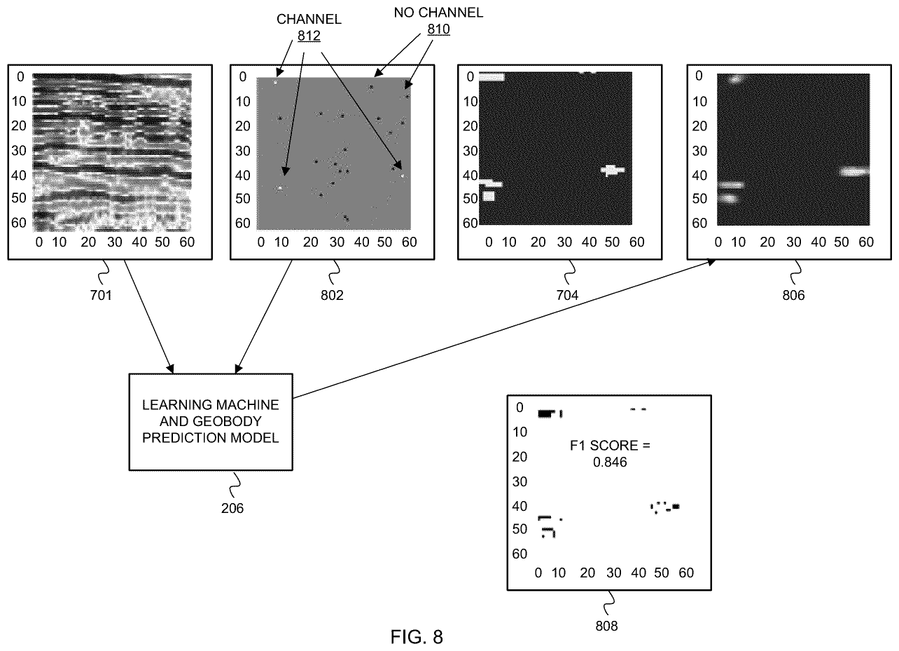

FIG. 8 is a block diagram showing output tiles generated based on a seismic input tile and a labeled guide input tile. In FIG. 8, the learning machine 206 may receive a seismic input tile 701 and a labeled guide input tile 802. The guide input tile 802 includes labels 810 indicating regions (or points) that do not include a channel. Additionally, the guide input tile 802 may include labels 812 indicating regions (or points) that include a channel. Therefore, the learning machine 206 may be making a prediction based on the seismic input tile 701 and additional ground truth information in the guide input tile 802. The learning machine 206 may generate an output tile 806 indicating a prediction of where channels may exist in the seismic volume. The tile 808 shows a difference between the ground truth tile 704 and the output tile 806. The tile 808 may be white where the output tile 806 agrees with the ground truth tile 704 and black where the prediction is incorrect. The tile 806 shows an F1 score of 0.846. The F1 score of the tile 808 is greater than the F1 score of the output tile 708 (see FIG. 7). Therefore, guide input tiles that include labeling may lead to more accurate predictions by the learning machine 206.

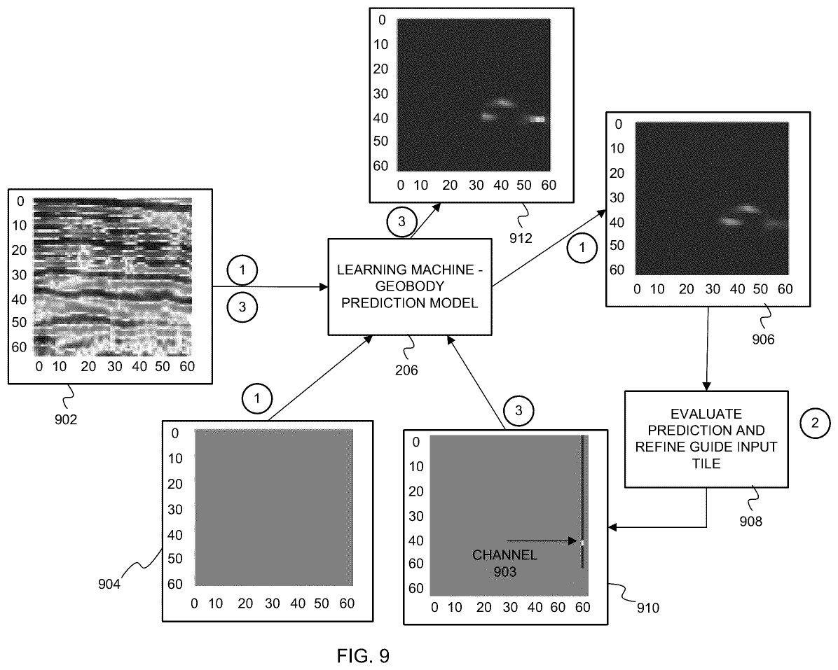

FIG. 9 the data flow diagram showing operations and data flow for iteratively improving predictions about a geobody in a seismic volume. In FIG. 9, operations occur in three stages. During stage 1, the learning machine 206 may receive a seismic input tile 902 and an unlabeled guide input tile 904. The unlabeled guide input tile 904 does not provide additional ground truth information beyond the seismic input tile 902. Based on the input tiles 902 and 904, the learning machine's geobody prediction model may generate an output tile 906 indicating a prediction about where geobodies may reside in the seismic volume.

During stage 2, a user or a computerized component (such as an application program) may evaluate the prediction in the output tile 906. The user or computerized component may refine the guide input tile by adding labels that provide additional ground truth information beyond the seismic input tile 902. The user-updated guide tile 910 may be created during stage 2. The user-updated guide tile 910 includes a label 903 indicating a region that includes a channel.

During stage 3, the learning machine 206 may generate the output tile 912 based on the seismic input tile 902 and the user-updated guide tile 910. The output tile 912 includes an additional prediction about where channels may reside in the seismic volume. The output tile 912 includes pixels of higher contrast than the output tile 906, thereby indicating a higher likelihood of a channel residing in a given location of the seismic volume. Hence, the operations of FIG. 9 enable an interactive process by which a user may evaluate a geobody prediction and provide additional ground truth information that may make a subsequent prediction more accurate. In some implementations, the refinement of the guide input tile may be performed by an automated component that inspects the output tile 906 and then refines the guide input tile.

Machine learning implementations of geobody classification may be performed using a convolutional neural network (such as a U-net). These neural networks may operate on tiles or rectangular cuboids of a fixed size. The size of the output tile/cuboid may be the same as the input tile/cuboid.

For example, in the case of a standard two-dimensional (2D) U-net (or similar to the model architecture) the input is of size N_{T}×Nₕ×N_{w}, where N_{T} is the number of tiles in the (training/validation/test) data set, Nh is the time height (number of rows per tile), and Nw is the tile with (number of columns per tile). The output in this case is also of size N_{T}×Nₙ×N_{w}. The square tiles are common, in which case Nₕ=N_{w}.

For a three-dimensional (3D) U-net, the input may be of size N_{C}×Nₕ×N_{w}×N_{d}, where NC is the number of rectangular cuboids in the (training/validation/test) data set, Nh is the cube height (number of rows per cuboid), N_{w} is is the cube with (number of columns per cuboid, and N_{d} is is the cube depth (number of slices per cuboid). The output in this case may also be of size N_{C}×Nₕ×N_{w}×N_{d}. It may be common for the rectangular cuboid to be acute, in which case Nh=N_{w}=N_{d}.

The above two cases may occur when only using seismic input. If the learning machine's model architecture supports additional guide input tiles, the size of the input tiles may change to N_{T}×Nₕ×N_{w}×2 in the 2D case, add size of the input rectangular cuboid may change to N_{C}×Nₕ×N_{w}×N_{d}×3 in the 3D case. In both cases the additional “×2” dimension may be due to the presence of two input features: the seismic signal and the additional guide input tile.

In some implementations, the seismic input may be 3D and the output may be 2D—with the latter typically corresponding to the central slice of the input cuboid. This case may be referred to as 2.5D. Tables 1 indicates various tile sizes.

TABLE 1

| | Size of Input | | Size of Input |
|---|---|---|---|
| | (Seismic only) | Size of Output | (Seismic and Guide) |
| 2D | N_{T} × | N_{T} × Nₕ × N_{w} | N_{T} × Nₕ × N_{w} × 2 |
| | Nₕ × N_{w} | | |
| 3D | N_{C} × | N_{C} × Nₕ × N_{w} × N_{d} | N_{C} × Nₕ × N_{w} × N_{d} × 2 |
| | Nₕ × N_{w} × N_{d} | | |
| 2.5 D | N_{C} × | N_{C} × Nₕ × N_{w} × 1 | N_{C} × Nₕ × N_{w} × N_{d} × 2 |
| | Nₕ × N_{w} × N_{d} | | |

Instead of representing the guide feature as a ternary categorical value, it may be represented as two features: one binary feature indicates if the guide has valid (non-null) input at a particular location, and another real-valued feature representing channel probability. In this case, the number of input features is 3—as shown below in Table 2.

TABLE 2

| | Size of Input | Size of Input | Size of Input |
|---|---|---|---|
| | (Seismic only) | (Seismic Only) | (Seismic and Guide) |
| 2D | N_{T} × | N_{T} × Nₕ × N_{w} | N_{T} × Nₕ × N_{w} × 3 |
| | Nₕ × N_{w} | | |
| 3D | N_{C} × | N_{C} × Nₕ × N_{w} × N_{d} | N_{C} × Nₕ × N_{w} × N_{d} × 3 |
| | Nₕ × N_{w} × N_{d} | | |
| 2.5 D | N_{C} × | N_{C} × Nₕ × N_{w} × 1 | N_{C} × Nₕ × N_{w} × N_{d} × 3 |
| | Nₕ × N_{w} × N_{d} | | |

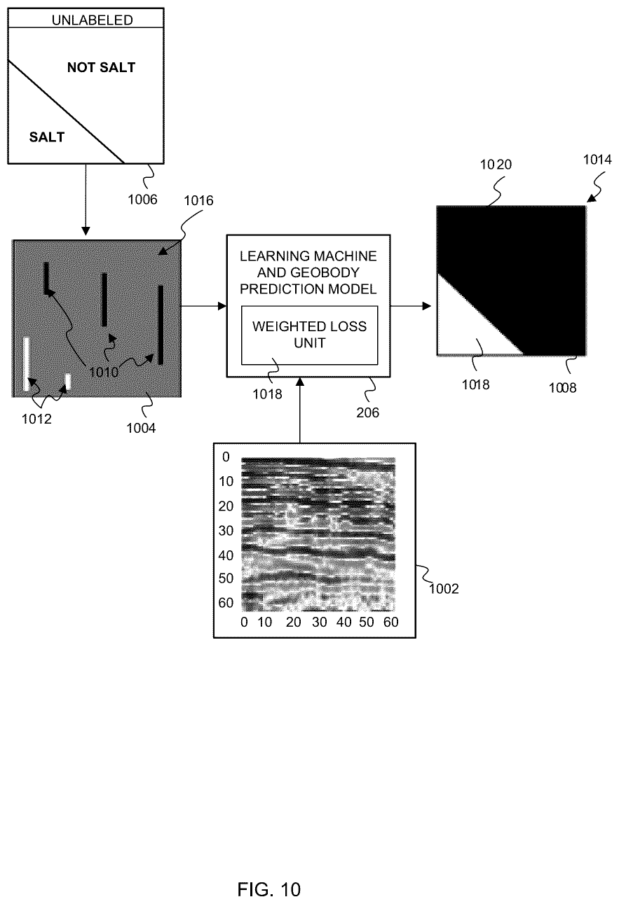

Some implementations of the learning machine may utilize a weighted loss function that applies zero weight (or a negligible weight such as 0.001 or a weight in the range of 0.002-0.009) to unlabeled regions of guide input tiles and nonzero weight to labeled regions of guide input tiles. When training the geobody prediction model, the training process may utilize a regression loss function such as Mean Square Error (MSE) function, Mean Absolute Error (MAE) function, or any other suitable regression loss function. In some implementations, the process for training the learning machine may utilize a binary cross-entropy function, a sparse categorical cross-entropy function, or any other suitable loss function. FIG. 10 shows an example weighted loss function.

FIG. 10 is a data flow diagram illustrating a learning machine that utilizes a weighted loss function to predict where geobodies may be in a seismic volume. A process for training the learning machine may utilize a ground truth tile 1006 that may include a first region labeled “salt”, a second region labeled “not salt”, and a third region that is unlabeled. During training, a guide input tile 1004 may be created based on the ground truth tile 1006. The guide input tile 1004 includes “salt” labels 1012 indicating regions of salt in the seismic volume and “not salt” labels 1010 indicating regions that do not include salt. The guide input tile 1004 includes a region 1016 that is unlabeled. Although the labels described in connection with FIG. 10 relate to salt, the labels may relate to any suitable geobody.

The learning machine 206 may include a weighted loss unit that may apply a weighted loss function to guide input tiles when training the geobody prediction model. The weighted loss function may apply zero weight to unlabeled regions of guide input tiles and non-zero weight to labeled regions. Hence, when ground truth is available for a region, the process may calculate prediction errors in the normal way (such as using a weighting of 1). For regions that do not have an associated ground truth, the error cannot be determined. Therefore, a weighting of 0 may be applied to effectively ignore the error in the unlabelled regions.

During training, the learning machine 206 may receive the guide input tile 1004 and the seismic input tile 1002. Based on the guide input tile 1004, seismic input tile 1002, and weighted loss function, the learning machine 206 may generate an output tile 1008. The output tile 1008 indicates a prediction about the presence of salt in the seismic volume. In the output tile 1008, the black region 1020 indicates likelihood of an absence of salt and the white region 1018 indicates likelihood of salt being present.

After training, the learning machine 206 may be used to make predictions. When making predictions, the ground truth tile 1006 may not be available. When making predictions, the learning machine 206 may receive the guide input tile 1004 and the seismic input tile 1002. Based on the tiles 1002 and 1004, the learning machine 206 may make predictions such as by generating the output tile 1008.

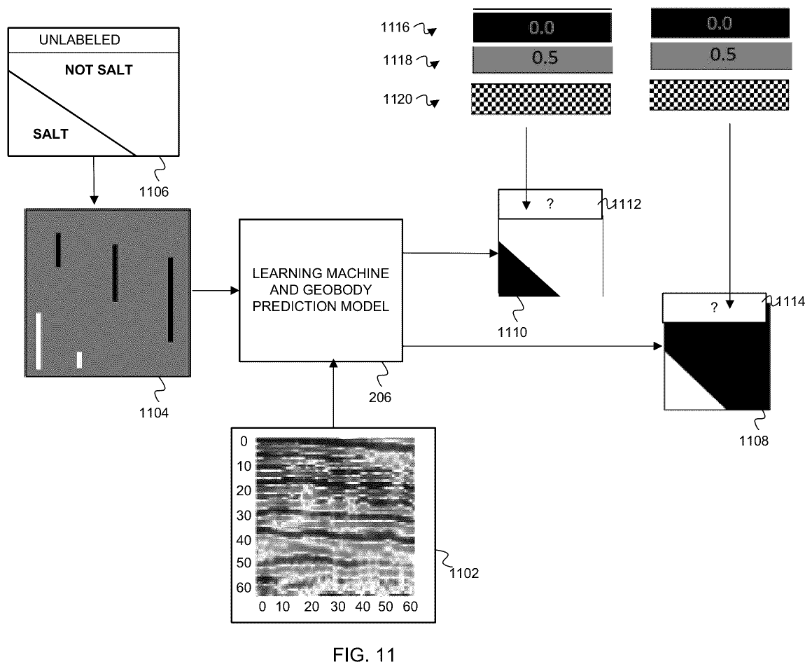

Some implementations may generate a plurality of output tiles based on a seismic input tile and a guide input tile. FIG. 11 describes this in greater detail.

FIG. 11 is a data flow diagram illustrating operations by which a learning machine generates a plurality of output tiles that indicate a prediction about a geobody in a seismic volume. In FIG. 11, a ground truth tile 1106 includes an unlabeled region. In some instances, the region remains unlabeled because a user may not have enough information to warrant a particular label. For example, a user (or application program or other component) may not have enough information to know whether the region should be labeled “salt” or “not salt”, so the region remains unlabeled. For such instances, the operations described with respect to FIG. 11 may be applicable. For the operations shown in FIG. 11, the learning machine 206 may utilize an unweighted loss function during training.

During the training process, a guide input tile 1104 may be created based on the ground truth tile 1106. The ground truth tile 1106 may have an unlabeled region and therefore the guide input tile 1104 may have an unlabeled region. The learning machine 206 may receive the guide input tile 1104 and a seismic input tile 1102. The learning machine 206 may generate two output tiles 1008 and 1110 indicating (respectively) a prediction about salt (or not salt) in a seismic volume. In output tile 1110, the probability of “salt” is shown, with white indicating a 100% probability of salt, and black a 0% probability of salt. And in output tile 1108, the probability of “not salt” is shown, with white indicating a 100% probability of “not salt”, and black a 0% probability of “not salt”. Although FIG. 11 relates to salt, the learning machine 206 may perform similar operations for any suitable geobody.

During training of the learning machine, the output tile 1110 includes a region 1112 corresponding to the unlabeled region of the ground truth tile 1106. Similarly, the output tile 1108 includes a region 1114 corresponding to the unlabeled region of the ground truth tile 1106. In cases where the unlabeled regions of the ground truth tile 1106 and the guide input tile 1104 were unlabeled for lack of understanding or information that would support a particular label, the learning machine 206 could be trained to define the regions 1112 and 1114 based on the labels 1116, 1118, and 1120. For example, if the learning machine 206 defined unlabeled regions based on the label 1116, the regions 1112 and 1114 would indicate that no prediction has been made about whether the regions 1112 and 1114 are salt or not salt. As another example, defining the regions 1112 and 1114 based on the label 1118 would indicate that the regions 1112 and 1114 have equal likelihood of being salt or not salt. Defining the regions 1112 and 1114 based on the label 1120 would show them as having random graphical patterns (such as a checker board, inverse checkerboard, or random scattering of 1s and 0s). The labels 1116, 1118, and 1120 enable a level of uncertainty for the predictions of the learning machine 206. The uncertainty may be interpreted in ways that may be useful in understanding whether a geobody may be present in a region of an output tile.

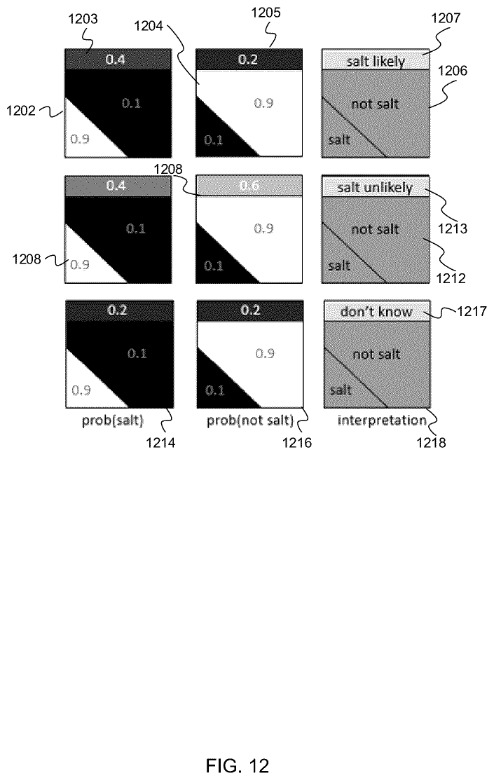

FIG. 12 is a block diagram illustrating example interpretations and predictions about a geobody in a seismic volume. The learning machine 206 may generate the output tiles 1202 and 1204 based on a guide input tile and a seismic input tile. In output tile 1202, a region 1203 indicates a 40% likelihood of salt. The black region indicates a 10% likelihood of salt and the white region indicates a 90% likelihood of salt. In the output tile 1204, a region 1205 indicates a 20% likelihood of not salt. The black region indicates a 10% likelihood of not salt and the white region indicates a 90% likelihood of not salt.

As noted above, the regions 1203 and 1205 may correspond to an unlabeled region of a guide input tile. If the learning machine 206 were trained to interpret the unlabeled region as indicating that there is no prediction about salt and not salt (see discussion of label 1116), the learning machine may interpret the results as shown in output tile 1206. The region 1207 of the interpretation tile 1206 indicates that salt is likely based on the 40% (output tile 1202) is greater than 20% probability of no salt.

Referring to the third row, if the same assumption is made about unlabeled regions, the learning machine may interpret the region 1217 of interpretation tile 1218 as “unknown” because the probabilities of salt and no salt are equal.

In the middle row, the learning machine 206 may have defined unlabeled regions as having equal likelihood of being salt or no salt (see discussion of label 1118 in FIG. 11). The output tile 1208 indicates a 40% likelihood of salt. The output tile 1206 indicates a 60% likelihood of no salt. Hence, the learning machine 206 may indicate “salt unlikely” in the region 1213 of the interpretation tile 1212.

The following table shows a summary of the possible permutations of labeling, loss function type, and number of output channels.

TABLE 3

| | Training & | | | |
|---|---|---|---|---|
| | Validation | Loss | Output | |
| # | Data | Function | Channels | Comment |
| #1 | Fully | Unweighted | 1 | |
| | Labelled | | | |
| #2 | Fully | Unweighted | 2 | May not have an advantage over #1. May |
| | Labelled | | | only produce a second (no salt) output that is |
| | | | | just the inverse of the first (salt). |
| #3 | Fully | Weighted | 1 | May not have an advantage over #1. If the |
| | Labelled | | | data is fully labelled and the target output is |
| | | | | binary, there may not be any advantage to |
| | | | | using a weighted loss. |
| #4 | Fully | Weighted | 2 | May not have an advantage over #1. See |
| | Labelled | | | comments for #2 and #3. |
| #5 | Partially | Unweighted | 1 | May be less flexible than #6. May be more |
| | Labelled | | | likely to |
| | | | | consistently either over-estimate or under- |
| | | | | estimate |
| | | | | the presence of salt in unlabelled areas |
| | | | | (depending on the choice of labelling |
| | | | | method). |
| #6 | Partially | Unweighted | 2 | This option may be preferred if the unlabelled |
| | Labelled | | | data is unlabelled primarily because it is a |
| | | | | “unknown”. For example, if someone |
| | | | | manually labels the readily apparent salt/no |
| | | | | salt regions, and leaves the remainder (the |
| | | | | most difficult cases) unlabelled. Allows |
| | | | | uncertainty estimate. |
| #7 | Partially | Weighted | 1 | May work well when we have some |
| | Labelled | | | unlabelled data present in our dataset. By |
| | | | | using an appropriately weighted loss, the |
| | | | | learning machine may effectively ignore the |
| | | | | unlabelled data, so that it does not adversely |
| | | | | affect training. |
| #8 | Partially | Weighted | 2 | May not have any advantage over #7 if |
| | Labelled | | | weight applied to unlabelled areas is zero. In |
| | | | | that case, it would only produce a second (no |
| | | | | salt) output that may be just the inverse of the |
| | | | | first (salt). However, in the case where |
| | | | | unlabeled areas have a small positive weight, |
| | | | | this may have some of the benefits of #6. |

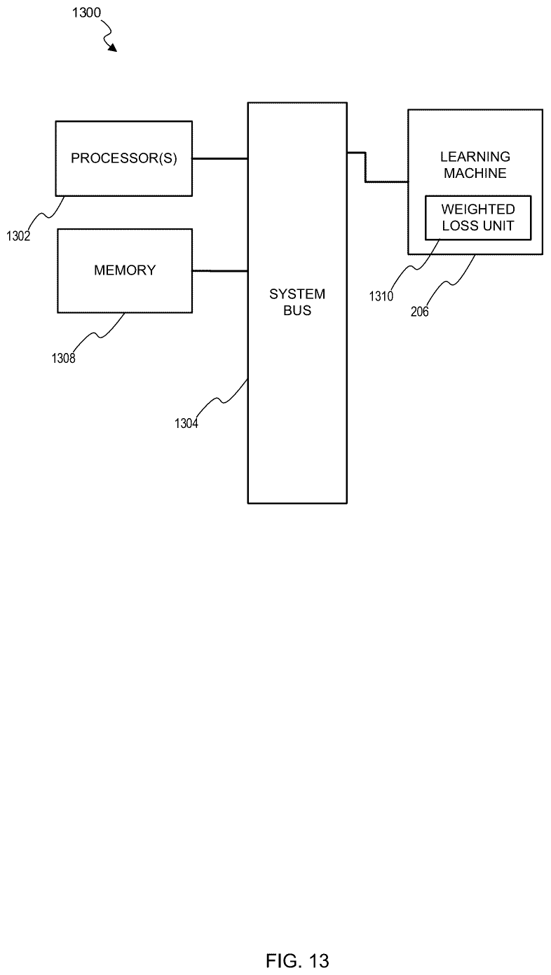

FIG. 13 is a block diagram illustrating a computer system, according to some aspects. In FIG. 13, a computer system 1300 may include one or more processors 1302 connected to a system bus 1304. The system bus 1304 may be connected to memory 1308. The memory 1308 may include any suitable memory random access memory (RAM), non-volatile memory (e.g., magnetic memory device), and/or any device for storing information and instructions executable by the processor(s) 1302.

In some aspects, the computer system 1300 can include additional peripheral devices. For example, in some aspects, the computer system 1300 can include multiple external multiple processors. In some aspects, any of the components can be integrated or subdivided.

The computer system 1300 also may include a learning machine 206. The learning machine may implement the methods described herein. In some implementations, the learning machine 206 may include components that implement machine learning operations related to identifying geobodies based on seismic input tiles and guide input tiles (as described herein). In some implementations, the computer system 1300 may be referred to as a learning machine that implements the inventive methods and techniques described herein. The learning machine may include a weighted loss unit 1310 that implements a weighted loss function during training (as described herein). The learning machine may include any suitable convolutional neural network (CNN) architecture such as a U-net. The U-Net may include an encoder and a decoder path. The encoder path may gradually reduce the spatial resolution of the input image (e.g., a seismic input tile or a guide input tile) and extract high-level features, while the decoder path upsamples the feature maps and recovers the spatial resolution. Skip connections between the corresponding layers of the encoder and decoder paths may enable the network to preserve fine-grained details during the upsampling process.

The learning machine 206 may perform training operations that implement supervised learning or any other suitable learning methodology. For example, the training operations may include inputting seismic training tiles including labels that indicate actual regions of the geobody in the seismic volume, and inputting guide training tiles including labeled data points that indicate presence or absence of the geobody at a particular region in the volume. The training operations also may include determining, based on the seismic training tiles and the guide training tiles, predicted regions of the geobodies in the seismic volume, and updating the learning machine based on errors between the predicted regions and the actual locations.

In some implementations, the learning machine may be part of any suitable computing device or system. Any component of the computer system 1300 may be implemented as hardware, firmware, and/or machine-readable media including computer-executable instructions for performing the operations described herein. For example, some implementations include one or more non-transitory machine-readable media including computer-executable instructions including program code configured to perform functionality described herein. Machine-readable media includes any mechanism that provides (e.g., stores and/or transmits) information in a form readable by a machine (e.g., a computer system). For example, tangible machine-readable media includes read only memory (ROM), random access memory (RAM), magnetic disk storage media, optical storage media, flash memory machines, etc. Machine-readable media also includes any media suitable for transmitting software over a network.

In some implementations, the learning machine may include any suitable convolutional neural network. For example, the learning machine

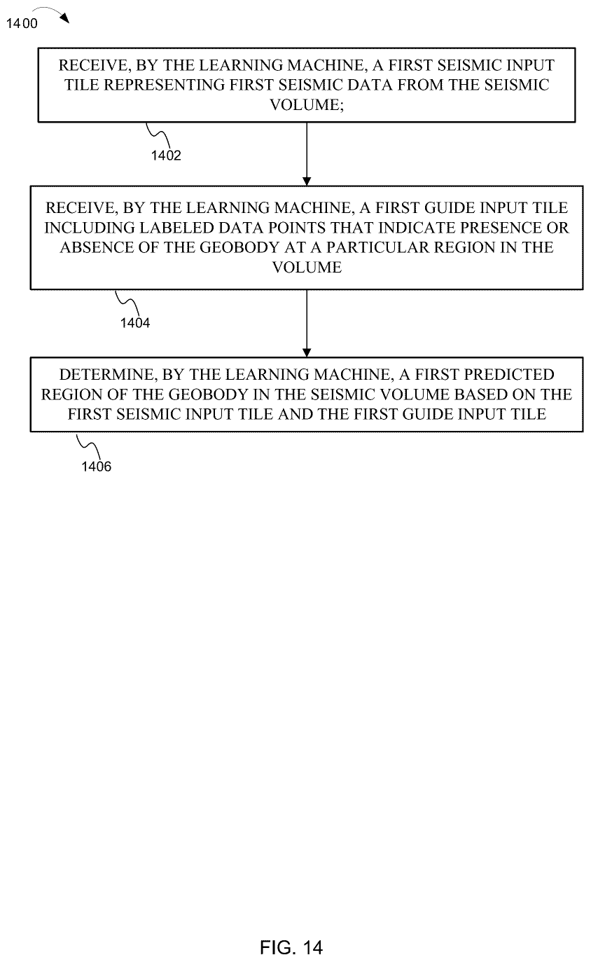

FIG. 14 a flow diagram illustrating a method for detecting, by a learning machine, a geobody in a seismic volume. Flow 1400 begins at block 1402. At block 1402, a learning machine receives a first seismic input tile representing first seismic data from the seismic volume. At block 1404, the learning machine receives a first guide input tile including labeled data points that indicate presence or absence of the geobody at a particular region in the volume. At block 1406, the learning machine determines, based on the first seismic input tile and the first guide input tile, a first predicted region of the seismic volume that includes the geobody.

### General Comments

FIGS. 1-14 and the operations described herein are examples meant to aid in understanding example implementations and should not be used to limit the potential implementations or limit the scope of the claims. None of the implementations described herein may be performed in the human mind nor using pencil and paper. None of the implementations described herein may be performed without the computerized components described herein. Any of the tiles described herein may be in any format suitable for presentation on a computer display and/or reading by a computer system. Any reference to the tiles or other components being in a computer-readable or computer-presentable format exclude human-created versions such as tiles drawn or otherwise made by a human without a computer. Some implementations may perform additional operations, fewer operations, operations in parallel or in a different order, and some operations differently.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described throughout. Whether such functionality is implemented in hardware or software depends upon the particular application and design constraints imposed on the overall system.

The hardware and data processing apparatus used to implement the various illustrative logics, logical blocks, modules and circuits described in connection with the implementations disclosed herein may be implemented or performed with a general purpose single- or multi-chip processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor or any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more implementations, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, e.g., one or more modules of computer program instructions stored on a computer storage media for execution by, or to control the operation of, a computing device.

If implemented in software, the functions may be stored on or transmitted over as one or more instructions or code on a computer-readable medium. The processes of a method or algorithm disclosed herein may be implemented in a processor-executable instructions which may reside on a computer-readable medium. Computer-readable media includes both computer storage media and communication media including any medium that may be enabled to transfer a computer program from one place to another. Storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-Ray™ disc where disks usually reproduce data magnetically, while discs reproduce data optically with lasers. Combinations also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, the terms “upper” and “lower” are sometimes used for ease of describing the Figures and indicate relative positions corresponding to the orientation of the Figure on a properly oriented page and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example process in the form of a flow diagram. However, some operations may be omitted and/or other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described should not be understood as requiring such separation in all implementations, and the described program components and systems may generally be integrated together in a single software product or packaged into multiple software products. Additionally, other implementations are within the scope of the following claims. In some cases, the actions recited in the claims may be performed in a different order and still achieve desirable results.

### EXAMPLE CLAUSES

Some implementations may include the following clauses.
Clause 1: A method for detecting, by a learning machine, a geobody in a seismic volume, the method comprising: receiving a first seismic input tile representing first seismic data from the seismic volume; receiving a first guide input tile including first labels that indicate presence of the geobody in a respective region in the seismic volume or absence of the geobody in the respective region, and one or more unlabeled regions that make no indication about presence or absence of the geobody; and determining, based on the first seismic input tile and the first guide input tile, a first prediction about geobody presence or absence in the seismic volume.
Clause 2: The method of clause 1 further comprising: generating an output tile that graphically illustrates the first prediction.
Clause 3: The method of any one or more of clauses 1-2 further comprising: determining, based on the first prediction, a second guide input tile including second labels that indicate presence or absence of the geobody at a particular region in the seismic volume; and receiving the second guide input tile; determining a second prediction about the geobody in the seismic volume based on the first seismic input tile and second guide input tile.
Clause 4: The method of any one or more of clauses 1-3 further comprising: training the learning machine by inputting seismic training tiles including second labels that indicate actual regions of the geobody in the seismic volume, inputting guide training tiles including third labels that indicate presence or absence of the geobody at a particular region in the volume, determining, based on the seismic training tiles and the guide training tiles, predicted regions of the geobody in the seismic volume, and updating the learning machine based on errors between the predicted regions and the actual regions.
Clause 5: The method of any one or more of clauses 1-4, wherein a weighted loss function quantifies the errors, and wherein no weight is given to the unlabeled regions of the first guide input tile.
Clause 6: The method of any one or more of clauses 1-5 further comprising: generating a first output tile including a first predicted region including the first prediction, a second predicted region in the seismic volume indicating absence of the geobody, and a third redicted region in the seismic volume indicating zero probability that the geobody is in the second predicted region, 50 percent probability that the geobody resides in the second predicted region, or random data patterns.
Clause 7: The method of any one or more of clauses 1-6 further comprising: generating a second output tile including, for each of a fourth predicted region, fifth predicted region, and sixth predicted region, an indication that the geobody is likely to be present or not likely to be present in the respective predicted region, wherein the first output tile indicates a probability the geobody is present at any point in the first output tile, and wherein the second output tile indicates a probability the geobody is absent at any point in the second output tile.
Clause 8: The method of any one or more of clauses 1-7, wherein the first seismic input tile and the first guide input tile are represented in one or more computerized graphical formats.
Clause 9: The method of any one or more of clauses 1-8, wherein the first prediction about the geobody in the seismic volume indicates that the geobody is absent from the seismic volume.
Clause 10: The method of any one or more of clauses 1-9, wherein a weighted loss function quantifies the errors, and wherein a negligible weight is given to unlabeled regions of the first guide input tile.
Clause 11: One or more machine-readable mediums including instructions that, when executed by one or more processors, perform operations detecting, by a learning machine, a geobody in a seismic volume, the instructions comprising: instructions to receive a first seismic input tile representing first seismic data from the seismic volume; instructions to receive a first guide input tile including first labels that indicate presence of the geobody in a respective region in the seismic volume or absence of the geobody in the respective region, and one or more unlabeled regions that make no indication about presence or absence of the geobody; and instructions to determine, based on the first seismic input tile and the first guide input tile, a first prediction about geobody presence or absence in the seismic volume.
Clause 12: The one or more machine-readable mediums of clause 11, further comprising: instructions to generate an output tile that graphically illustrates the first prediction.
Clause 13: The one or more machine-readable mediums of any one or more of clauses 11-12, further comprising: instructions to determine, based on the first prediction, a second guide input tile including second labels that indicate presence or absence of the geobody at a particular region in the seismic volume; and instructions to receive the second guide input tile; instructions to determine a second prediction about the geobody in the seismic volume based on the first seismic input tile and second guide input tile.
Clause 14: The one or more machine-readable mediums of any one or more of clauses 11-13, further comprising: training the learning machine by instructions to input seismic training tiles including second labels that indicate actual regions of the geobody in the seismic volume, instructions to input guide training tiles including third labels that indicate presence or absence of the geobody at a particular region in the volume, instructions to determine, based on the seismic training tiles and the guide training tiles, predicted regions of the geobody in the seismic volume, and instructions to update the learning machine based on errors between the predicted regions and the actual regions
Clause 15: The one or more machine-readable mediums of any one or more of clauses 11-14, wherein a weighted loss function quantifies the errors, and wherein no weight is given to the unlabeled regions of the first guide input tile.
Clause 16: The one or more machine-readable mediums of any one or more of clauses 11-15 further comprising: instructions to generate a first output tile including the first predicted region, a second predicted region in the seismic volume indicating absence of the geobody, and a third predicted region in the seismic volume indicating zero probability that the geobody is in the second predicted region, 50 percent probability that the geobody resides in the second predicted region, or random data patterns.
Clause 17: An apparatus comprising: one or more processors; one or more machine-readable mediums including instructions that, when executed by one or more processors, perform operations for detecting, by a learning machine, a geobody in a seismic volume, the instructions including instructions to receive a first seismic input tile representing first seismic data from the seismic volume; instructions to receive a first guide input tile including first labels that indicate presence of the geobody in a respective region in the seismic volume or absence of the geobody in the respective region, and one or more unlabeled regions that make no indication about presence or absence of the geobody; and instructions to determine, based on the first seismic input tile and the first guide input tile, a first prediction about geobody presence or absence in the seismic volume.
Clause 18: The apparatus of any one or more of clauses 15-17 further comprising: instructions to generate an output tile that graphically illustrates the first prediction.
Clause 19: The apparatus of any one or more of clauses 15-18 further comprising: instructions to determine, based on the first prediction, a second guide input tile including second labels that indicate presence or absence of the geobody at a particular region in the seismic volume; and instructions to receive the second guide input tile; instructions to determine a second prediction about the geobody in the seismic volume based on the first seismic input tile and second guide input tile.
Clause 20: The apparatus of any one or more of clauses 15-19 further comprising: instructions to train the learning machine including instructions to input seismic training tiles including second labels that indicate actual regions of the geobody in the seismic volume, instructions to input guide training tiles including third labels that indicate presence or absence of the geobody at a particular region in the volume, instructions to determine, based on the seismic training tiles and the guide training tiles, predicted regions of the geobody in the seismic volume, and instructions to update the learning machine based on errors between the predicted regions and the actual regions.

What is claimed is:

1. A method for detecting, by a learning machine, a geobody in a seismic volume, the method comprising:
receiving a first seismic input tile representing first seismic data from the seismic volume;
receiving a first guide input tile including
first labels that indicate presence of the geobody in a respective region in the seismic volume or absence of the geobody in the respective region, and
one or more unlabeled regions that make no indication about presence or absence of the geobody; and
determining, based on the first seismic input tile and the first guide input tile, a first prediction about geobody presence or absence in the seismic volume.

2. The method of claim 1, the method further comprising:
generating an output tile that graphically illustrates the first prediction.

3. The method of claim 1 further comprising:
determining, based on the first prediction, a second guide input tile including second labels that indicate presence or absence of the geobody at a particular region in the seismic volume; and
receiving the second guide input tile;
determining a second prediction about the geobody in the seismic volume based on the first seismic input tile and second guide input tile.

4. The method of claim 1 further comprising:
training the learning machine by
inputting seismic training tiles including second labels that indicate actual regions of the geobody in the seismic volume,
inputting guide training tiles including third labels that indicate presence or absence of the geobody at a particular region in the volume,
determining, based on the seismic training tiles and the guide training tiles, predicted regions of the geobody in the seismic volume, and
updating the learning machine based on errors between the predicted regions and the actual regions.

5. The method of claim 4, wherein a weighted loss function quantifies the errors, and wherein no weight is given to the unlabeled regions of the first guide input tile.

6. The method of claim 4 further comprising:
generating a first output tile including
a first predicted region including the first prediction,
a second predicted region in the seismic volume indicating absence of the geobody, and
a third predicted region in the seismic volume indicating zero probability that the geobody is in the second predicted region, 50 percent probability that the geobody resides in the second predicted region, or random data patterns.

7. The method of claim 6 further comprising:
generating a second output tile including, for each of a fourth predicted region, fifth predicted region, and sixth predicted region, an indication that the geobody is likely to be present or not likely to be present in the respective predicted region, wherein the first output tile indicates a probability the geobody is present at any point in the first output tile, and wherein the second output tile indicates a probability the geobody is absent at any point in the second output tile.

8. The method of claim 1, wherein the first seismic input tile and the first guide input tile are represented in one or more computerized graphical formats.

9. The method of claim 1, wherein the first prediction about the geobody in the seismic volume indicates that the geobody is absent from the seismic volume.

10. The method of claim 4, where a weighted loss function quantifies the errors, and wherein a negligible weight is given to unlabeled regions of the first guide input tile.

11. One or more machine-readable mediums including instructions that, when executed by one or more processors, perform operations detecting, by a learning machine, a geobody in a seismic volume, the instructions comprising:
instructions to receive a first seismic input tile representing first seismic data from the seismic volume;
instructions to receive a first guide input tile including
first labels that indicate presence of the geobody in a respective region in the seismic volume or absence of the geobody in the respective region, and
one or more unlabeled regions that make no indication about presence or absence of the geobody; and
instructions to determine, based on the first seismic input tile and the first guide input tile, a first prediction about geobody presence or absence in the seismic volume.

12. The one or more machine-readable mediums of claim 11 further comprising:
instructions to generate an output tile that graphically illustrates the first prediction.

13. The one or more machine-readable mediums of claim 11 further comprising:
instructions to determine, based on the first prediction, a second guide input tile including second labels that indicate presence or absence of the geobody at a particular region in the seismic volume; and
instructions to receive the second guide input tile;
instructions to determine a second prediction about the geobody in the seismic volume based on the first seismic input tile and second guide input tile.

14. The one or more machine-readable mediums of claim 11 further comprising:
training the learning machine by
instructions to input seismic training tiles including second labels that indicate actual regions of the geobody in the seismic volume,
instructions to input guide training tiles including third labels that indicate presence or absence of the geobody at a particular region in the volume,
instructions to determine, based on the seismic training tiles and the guide training tiles, predicted regions of the geobody in the seismic volume, and
instructions to update the learning machine based on errors between the predicted regions and the actual regions.

15. The one or more machine-readable mediums of claim 14, wherein a weighted loss function quantifies the errors, and wherein no weight is given to the unlabeled regions of the first guide input tile.

16. The one or more machine-readable mediums of claim 14 further comprising:
instructions to generate a first output tile including
the first predicted region,
a second predicted region in the seismic volume indicating absence of the geobody, and
a third predicted region in the seismic volume indicating zero probability that the geobody is in the second predicted region, 50 percent probability that the geobody resides in the second predicted region, or random data patterns.

17. An apparatus comprising:
one or more processors;
one or more machine-readable mediums including instructions that, when executed by
one or more processors, perform operations for detecting, by a learning machine, a geobody in a seismic volume, the instructions including
instructions to receive a first seismic input tile representing first seismic data from the seismic volume;
instructions to receive a first guide input tile including
first labels that indicate presence of the geobody in a respective region in the seismic volume or absence of the geobody in the respective region, and
one or more unlabeled regions that make no indication about presence or absence of the geobody; and
instructions to determine, based on the first seismic input tile and the first guide input tile, a first prediction about geobody presence or absence in the seismic volume.

18. The apparatus of claim 17 further comprising:
instructions to generate an output tile that graphically illustrates the first prediction.

19. The apparatus of claim 17 further comprising:
instructions to determine, based on the first prediction, a second guide input tile including second labels that indicate presence or absence of the geobody at a particular region in the seismic volume; and
instructions to receive the second guide input tile;
instructions to determine a second prediction about the geobody in the seismic volume based on the first seismic input tile and second guide input tile.

20. The apparatus of claim 17 further comprising:
instructions to train the learning machine including
instructions to input seismic training tiles including second labels that indicate actual regions of the geobody in the seismic volume,
instructions to input guide training tiles including third labels that indicate presence or absence of the geobody at a particular region in the volume,
instructions to determine, based on the seismic training tiles and the guide training tiles, predicted regions of the geobody in the seismic volume, and
instructions to update the learning machine based on errors between the predicted regions and the actual regions.
